(19) United States
(12) Patent Application Publication
(10) Pub. No.: US 2005/0187132 A1
(43) Pub. Date: Aug. 25, 2005

(54) Detergent composition which has been compacted under pressure

(76) Inventors: Volker Blank, Leverkusen (DE); Henriette Weber, Vienna (AT); Kathrin Schnepp-Hentrich, Duesseldorf (DE); Wilfried Raehse, Duesseldorf (DE)

Correspondence Address: HENKEL CORPORATION, THE TRIAD, SUITE 200, 2200 RENAISSANCE BLVD., GULPH MILLS, PA, 19406, US

(21) Appl. No.: 11/079,046

(22) Filed: Mar. 14, 2005

Related U.S. Application Data
(63) Continuation of application No. PCT/EP03/09983, filed on Sep. 9, 2003.

(30) Foreign Application Priority Data
Sep. 12, 2002 (DE) 102 42 222.2

(51) Int. Cl. C11D 17/00

(52) U.S. Cl. 510/446

(57) ABSTRACT

Detergent compositions comprising a compactate, wherein the compactate contains one or more organic polycarboxylic acids and/or salts thereof and no more than 5% by weight of water-insoluble builder substances, and the pH of a 1% solution of the detergent composition in water at 20° C. is below 10.5.

### CROSS REFERENCE TO RELATED APPLICATIONS

This application is a continuation under 35 U.S.C. § 365(c) and 35 U.S.C. § 120 of international application PCT/EP2003/009983, filed Sep. 9, 2003. This application also claims priority under 35 U.S.C. § 119 of DE 102 42 222.2, filed Sep. 12, 2002, which is incorporated herein by reference in its entirety.

### BACKGROUND OF THE INVENTION

The present invention relates to a detergent composition which has been compacted, especially extruded, under mechanical pressure and comprises organic polycarboxylic acids and predominantly water-soluble builder substances and has a pH of less than 10.5, and to a process for producing these compositions.

Particulate detergents having bulk densities above 750 g/l, even above 800 g/l, have formed part of the prior art for some time. The increase in the bulk density was accompanied by a concentration of the washing and cleaning ingredients, so that the consumer not only had to measure less volume, but also less mass, per washing or cleaning operation. The process for producing heavy detergents has been optimized in the last few years to the effect that ever more concentrated compositions with still further increased bulk densities have resulted. The extrusion process, for example according to European patent EP 0486592 B1, is an example thereof. The process mentioned provides extruded detergents which preferably have a bulk density above 750 g/l, and even values of from 950 to 980 g/l are attained. The increase in the bulk density and in particular, again, the higher concentration of detergent substances in the compositions has generally been achieved at the cost, perceived subjectively by the consumer, of poorer solubility which is reflected in a slower dissolution rate of the composition employed. From the consumer's point of view, it is therefore actually desirable that products having lower bulk densities become available.

According to the teaching of the international patent application WO 98/12299 too, extruded detergents with bulk densities of from 750 g/l to 1000 g/l are obtained. It was possible to solve the solubility problem by carrying out the extrusion virtually anhydrously, the premixture not having contained any free water and bound water only in particular amounts. The binders used which have simultaneous lubricant and adhesive function are raw materials or compounds which have solid character at a pressure of 1 bar and temperatures below 45° C., and only soften or melt above this temperature, but are in liquid form under the processing conditions. Preferred binders which are specified and can be used alone or in a mixture with other binders are polyethylene glycols, 1,2-polypropylene glycols and modified polyethylene glycols and polypropylene glycols. The modified polyalkylene glycols include in particular the sulfates and/or the disulfates of polyethylene glycols or polypropylene glycols having a relative molecular mass between 600 and 12 000 and in particular between 1000 and 4000. A further group consists of mono- and/or disuccinates of polyalkylene glycols which in turn have relative molecular masses between 600 and 6000, preferably between 1000 and 4000. For a more precise description of the modified polyalkylene glycol ethers, reference is made to the disclosure of the international patent application WO-A-93/02176. In the context of this invention, polyethylene glycols include polymers which have been prepared using not only ethylene glycol but also C₃-C₅ glycols and glycerol and mixtures thereof as starter molecules. In addition, ethoxylated derivatives such as trimethylolpropane with from 5 to 30 EO are also included. The polyethylene glycols used with preference may have a linear or branched structure, and preference is given in particular to linear polyethylene glycols. For a more comprehensive description of the binders, reference is made at this point explicitly to the disclosure of the international patent application WO 98/12299. The extrusion is carried out virtually anhydrously. This means that the premixture to be extruded does not contain any free water and the content of chemically or physically bound water is also restricted. Extruded detergents produced in this way comprise, as surfactants, in particular anionic surfactants which are introduced into the premixture in solid form, inorganic and/or organic builder substances and further customary ingredients of detergents. The inorganic builder substances mentioned are in particular aluminosilicates of the zeolite type. In the disclosed formulations, these zeolites provide the main constituent of the builder substances present overall. In addition to further possible inorganic builder substances such as carbonates and/or silicates, the organic builder substances are in particular (co)polymeric polycarboxylates, but also the polycarboxylic acids which can be used in the form of their sodium salts, polycarboxylic acids referring to those carboxylic acids which bear more than one acid function. In fact, it is disclosed that it is also possible in principle to use the polycarboxylic acids themselves, since, in addition to their builder action, they also have an acidification component and can thus also contribute to the setting of a lower and milder pH of detergents. Depending on the formulation, the pH of detergents, especially in the case of high-performance heavy-duty detergents or machine dishwashing detergents, is usually above 10.5, and even values up to 11.5 can be encountered. However, it is also stated that the polycarboxylic acids themselves are either mixed in subsequently or used in anhydrous form in the premixture, the subsequent mixing being the customary procedure. There is no disclosure either of examples in which solid premixtures which comprise polycarboxylic acids or of information as to how the other builder substances in the premixture should be adjusted if appropriate to this acidic component.

Detergents which are produced according to the teaching of the European patent EP 0486592 B1 or of the international patent application WO 98/12299, have high acceptance by the consumer owing to their relatively uniform appearance in addition to their performance properties.

However, it has now been found that extrudates which have been produced according to the process of the international patent application WO 98/12299 and comprise a builder system which has zeolite as its main constituent, in the case of the use of even small amounts of polycarboxylic acids in the premixture, do have a desired bulk density reduced to below 750 g/l but at the same time a fragrance altered in an unacceptable manner. Without wishing to commit to this explanation, it is the assumption of the applicant that the polycarboxylic acids are not neutralized fully during the extrusion or when they pass through the perforated plate of the extruder, as a result of which, with hindsight, what are known as “acid pockets” are formed in combination with the zeolite and alter the odor of the extrudates in said unacceptable manner. Measured pH values of the composition of below 10.5 (1% solution; at 20° C.) appear to confirm this theory. Experience has also shown that this unpleasant acidic odor cannot be masked subsequently by separately added fragrances; on the contrary, perfumes are typically attacked by the acidic constituents, so that the desired perfume fragrance changes to another undesired and unpleasant note. It therefore appears to be impossible to produce detergents having relatively low pH values by compactions, especially extrusion processes, carried out under pressure.

### DESCRIPTION OF THE INVENTION

The invention therefore provides, in a first embodiment, a detergent composition which has been compacted, especially extruded, under pressure, or compound therefor, which comprises organic polycarboxylic acids and/or salts thereof, but not more than 5% by weight of water-insoluble builder substances, the pH of a 1% solution of the composition in water at 20° C. being below 10.5.

The compositions comprise organic polycarboxylic acids and/or salts thereof, the use of organic polycarboxylic acids in the production of the compositions not being obligatory but preferred, and the use both of organic polycarboxylic acids and salts thereof in the production being of particular advantage and therefore especially preferred. In the finished composition, a distinction can no longer be drawn between organic polycarboxylates used originally as a salt and salts which have formed in the production of the composition by neutralization of organic polycarboxylic acids. However, in the context of the present invention, mention is nevertheless made, in some places in the description of the compositions, of organic polycarboxylic acids present in the composition, in order to be able to distinguish between originally used salts and salts present as a result of neutralization in the process. Organic polycarboxylic acids in the composition thus refer to the amounts of salt which have formed in the preparation of the composition by neutralization of the organic polycarboxylic acids, and any residues of nonneutralized acid. Usable organic polycarboxylic acids and/or salts thereof are, for example, those which bear more than one acid function. For example, these are citric acid, adipic acid, succinic acid, glutaric acid, malic acid, tartaric acid, maleic acid, fumaric acid, sugar acids, aminocarboxylic acids, nitrilotriacetic acid (NTA), as long as such a use is not objectionable for ecological reasons, and mixtures thereof. Preference is given in this context to polycarboxylic acids such as citric acid, adipic acid, succinic acid, glutaric acid, tartaric acid, methylglycinediacetic acid, sugar acids and mixtures thereof. The salts are used preferably as alkali metal salts and in particular as sodium salts.

In an advantageous embodiment of the invention, the organic polycarboxylic acids and/or salts thereof which are used are a combination of 2 or more acids and/or salts thereof from the abovementioned group, and it is especially preferred that a composition comprises an organic polycarboxylic acid (which, as detailed above, has been at least partially neutralized in the course of preparation of the composition) and a salt of an organic polycarboxylic acid. In a further advantageous embodiment, the content of organic polycarboxylic acids and/or salts thereof in the compositions, based on the sum of the water-soluble builder substances, is at least 30% by weight and in particular at least 35% by weight, for example at least 40% by weight or even more than 50% by weight. At the same time, the compositions preferably contain from 5 to 35% by weight, in particular from 10 to 30% by weight and with very particular preference up to 25% by weight, of salts of organic polycarboxylic acids which have been used originally in the form of salts in the production of the compositions. The preferred content of organic polycarboxylic acids in the compositions is, in contrast, from 1 to 10% by weight and in particular from 1 to 5% by weight. In an advantageous embodiment, the sum of the total amount of salts of organic polycarboxylates present may therefore be from 5 to 45% by weight, but is preferably at contents of from 8 to 30% by weight and in particular of from 10 to 20% by weight.

The pH of the compositions (measured as a 1% solution in water at 20° C.) is preferably at most 10.2 and in particular at most 10.0. Owing to the mildness of the composition, very particular preference is given to values of from 9.0 to 9.9. It was surprising that it was possible to produce such mild compositions by compaction under pressure and that they nevertheless had an acceptable value in the fragrance assessment and an unchanged fragrance note compared to compositions having a higher pH.

In a further advantageous embodiment of the invention, the compositions have a bulk density which is not above 750 g/l. Surprisingly, it has been possible by compaction under pressure, especially by extrusion, to provide compositions which do not, as has been the case hitherto with this technology, have very high bulk densities of 750 g/l and typically higher, but rather which in particular even have bulk densities of not more than 720 g/l. In a very particularly preferred embodiment of the invention, the inventive compositions have bulk densities between 500 and 700 g/l.

The preferred inventive compositions comprise several advantages: they are, measured by their pH value, relatively mild and can thus subsequently be mixed with further alkaline constituents, without resulting in an excessively high alkalinity value of the formulated composition for domestic use, have an acceptable fragrance note unchanged compared to compositions having higher pH values, a relatively low bulk density desired by the consumer, and, in a further embodiment of the invention, additionally exhibit a relatively uniform outward appearance which is known and valued by the consumer from products which are produced by extrusion and sold under the Megaperls® trademark.

In a further embodiment of the invention, the builder substances present in the compositions are predominantly those which are soluble in water. These include not only the organic polycarboxylic acids already mentioned and/or salts thereof, but also further inorganic and/or organic builder substances. Especially useful inventive compositions comprise a builder system composed of organic and inorganic builder substances. The water-soluble inorganic builder substances are in particular selected from the group of the carbonates, amorphous alkali metal silicates, crystalline sheet silicates, phosphates and mixtures of two, three, four or even more of the builder substances mentioned.

The carbonates present in the compositions may be either the monoalkali metal salts or the dialkali metal salts of carbonic acid, or else sesquicarbonates. Preferred alkali metal ions are sodium and/or potassium ions. Compounds of, for example, carbonate, silicate and optionally further assistants, for example anionic surfactants or other, especially organic, builder-substances may also be used in the production of the inventive compositions.

It is also possible to use amorphous sodium silicates having an Na₂O:SiO₂ modulus of from 1:2 to 1:3.3, preferably from 1:2 to 1:2.8 and in particular from 1:2 to 1:2.6, which have retarded dissolution and secondary washing properties. The retardation of dissolution relative to conventional amorphous sodium silicates may have been brought about in a variety of ways, for example by surface treatment, compounding, compacting or by overdrying. In the context of this invention, the term “amorphous” also includes “X-ray-amorphous”. This means that, in X-ray diffraction experiments, the silicates do not afford any sharp X-ray reflections typical of crystalline substances, but rather yield at best one or more maxima of the scattered X-radiation, which have a width of several degree units of the diffraction angle. However, it may quite possibly lead to even particularly good builder properties if the silicate particles in electron diffraction experiments yield vague or even sharp diffraction maxima. This is to be interpreted such that the products have microcrystalline regions with a size of from 10 to several hundred nm, and preference is given to values up to a maximum of 50 nm and in particular up to a maximum of 20 nm. Particular preference is given to compacted amorphous silicates, compounded amorphous silicates and overdried X-ray-amorphous silicates.

Suitable crystalline, sheet-type sodium silicates have the general formula NaMSiₓO₂ₓ₊₁.H₂O where M is sodium or hydrogen, x is a number from 1.9 to 4, y is a number from 0 to 20, and preferred values for x are 2, 3 or 4. Preferred crystalline sheet silicates of the formula specified are those in which M is sodium and x assumes the values 2 or 3. In particular, both β- and also δ-sodium disilicates Na₂Si₂O₅.yH₂O are suitable. However, in the context of the present invention crystalline, sheet-type silicates are less preferred, because they have too low a dissolution rate and their processing in an extruder frequently leads to metal attrition.

It will be appreciated that it is also possible to use the commonly known phosphates as builder substances, as long as such a use should not be avoided for ecological reasons. Among the multitude of commercially available phosphates, the alkali metal phosphates, with particular preference for pentasodium phosphate and pentapotassium phosphate (sodium tripolyphosphate and potassium tripolyphosphate, respectively), have the greatest significance in the detergents industry.

Alkali metal phosphates is the collective term for the alkali metal (especially sodium and potassium) salts of the different phosphoric acids, for which a distinction can be drawn of metaphosphoric acids (HPO₃)ₙ and orthophosphoric acid H₃PO₄ from higher molecular weight representatives. The phosphates combine several advantages: they function as alkali carriers, prevent limescale films on machine parts and limescale deposits on the ware, and additionally contribute to the cleaning performance. Suitable phosphates are sodium dihydrogen phosphate, NaH₂PO₄, disodium hydrogen phosphate (secondary sodium phosphate), Na₂HPO₄, trisodium phosphate, tertiary sodium phosphate, Na₃PO₄, tetrasodium diphosphate (sodium pyrophosphate), Na₄P₂O₇, and the higher molecular weight sodium and potassium phosphates formed by condensation of NaH₂PO₄ or of KH₂PO₄, for which a distinction can be drawn between cyclic representatives, the sodium or potassium metaphosphates, and catenated types, the sodium or potassium polyphosphates. Especially for the latter, a multitude of names are in use: fused or calcined phosphates, Graham's salt, Kurrol's and Maddrell's salt. All higher sodium and potassium phosphates are referred to collectively as condensed phosphates. The industrially important pentasodium triphosphate, Na₅P₃O₁₀ (sodium tripolyphosphate) can be used in accordance with the invention, just like sodium tripolyphosphate, potassium tripolyphosphate or mixtures thereof; it is also possible in accordance with the invention to use mixtures of sodium tripolyphosphate and sodium potassium tripolyphosphate or mixtures of potassium tripolyphosphate and sodium potassium tripolyphosphate or mixtures of sodium tripolyphosphate and potassium tripolyphosphate and sodium potassium tripolyphosphate.

Especially preferred are compositions which comprise, as inorganic water-soluble builder substances, alkali metal carbonates and/or alkali metal bicarbonates, in particular sodium carbonates and/or sodium bicarbonates, particularly advantageous compositions being those which comprise a combination of carbonate, especially sodium carbonate, and bicarbonate, especially sodium bicarbonate, and also, if desired, further inorganic and/or organic water-soluble builder substances.

The content of alkali metal carbonate and/or alkali metal bicarbonate and especially of alkali metal carbonate and alkali metal bicarbonate in the inventive compositions, based on the sum of the water-soluble builder substances, is preferably from 10 to 80% by weight, in particular from 20 to 60% by weight. Formulations having less than 50% by weight and in particular having from 20 to 40% by weight, of alkali metal carbonate and/or alkali metal bicarbonate, based on the sum of the water-soluble builder systems, can have performance advantages, but are often less preferred for economic reasons. Instead, the content of alkali metal carbonate and/or alkali metal bicarbonate and especially of alkali metal carbonate and alkali metal bicarbonate in the compositions, based on the inventive compositions, is preferably from 1 to 30% by weight and in particular from 1 to 20% by weight, particular preference being given to contents of at least 5% by weight and in particular of at least 10% by weight.

Surprisingly, the use of predominantly water-soluble builder systems which comprise in particular at least sodium carbonate and/or sodium bicarbonate on the one hand and organic polycarboxylic acids, especially citric acid, on the other does not lead to a deterioration in the dissolution performance of the inventive compositions, as would have been expected according to experiments with builder systems composed of water-insoluble and water-soluble builders in combination with organic polycarboxylic acid. Instead, the inventive compositions have very good dissolution performance which is comparable with the dissolution performance of the extrudates which have been prepared according to WO 98/12299 and are based on zeolite as the main constituent of the builder system. Thus, inventive compositions have a solubility which, measured by the L test specified in the examples, has a value of from 1 to 20% by weight and in particular from 5 to 15% by weight.

In a further preferred embodiment, the inventive compositions comprise carbonate and/or bicarbonate and citric acid and/or citrate, the weight ratio of the sum of carbonate and/or bicarbonate to the sum of citric acid and/or citrate being between 3:1 and 1:2, in particular between 2:1 and 1:1.

Accordingly, the compositions which have been compacted and especially extruded under pressure do not contain more than 5% by weight of water-insoluble builder substances, which in particular include alumino-silicates, and among these in turn particularly the zeolites in detergent quality. The finely crystalline synthetic zeolite containing bound water which can be used is preferably zeolite A and/or zeolite P. The zeolite P is more preferably Zeolite MAP® (commercial product from Crosfield). Also suitable, however, are zeolite X and mixtures of A, X and/or P. Also commercially available and usable with preference in the context of the present invention is, for example, a cocrystal of zeolite X and zeolite A (approx. 80% by weight of zeolite X) which is sold by CONDEA Augusta S.p.A. under the brand name VEGOBOND AX® and can be described by the formula
nNa₂O.(1-n)K₂O Al₂O₃(2-2.5)SiO₂.(3.5-5.5)H₂O.

The zeolite is used generally as a spray-dried powder or as a compounded granule. Suitable fine pulverulent zeolites have an average particle size of less than 10 μm (volume distribution; measurement method: Coulter counter) and contain preferably from 18 to 22% by weight, in particular from 20 to 22% by weight, of bound water.

The inventive compositions may, though, be aftertreated with solids and/or liquids. The actual composition which is compacted and especially extruded under pressure constitutes the core of the inventive composition which, in addition to this core, has at least one partial or full shell which has been applied subsequently. It is particularly advantageous when the core of the inventive compositions comprises less than 5% by weight, preferably not more than 3% by weight and in particular not more than 2% by weight, of water-insoluble builder substances. Very particular preference is given to embodiments in which the core of the inventive compositions is free of water-insoluble builder substances and especially free of aluminosilicates, for example zeolites.

In a preferred embodiment of the invention, the composition has at least one partial or full shell composed of one or more liquids, and an aftertreatment with at least one solid, preferably a fine solid, is advantageously effected thereon.

In a further preferred embodiment, the core, which has been compacted and especially extruded under pressure, of the inventive compositions is aftertreated first with at least one solid, especially a fine solid, whereupon a further aftertreatment with at least one liquid and if desired further aftertreatments with solids and liquids in alternation can be effected. It is advantageous when the aftertreatment of the core is completed with a powdering with a solid, especially a fine solid.

Overall, it has been found to be advantageous when the core which has been compacted and especially extruded under mechanical pressure has been powdered with a water-soluble ingredient or a combination of two or more water-soluble ingredients, especially from the group of the amorphous silicates, sulfates, especially sodium sulfates, fatty acid salts, especially calcium stearate, alkali metal carbonates and other alkali metal hydrogen carbonates. These ingredients, also known as surface modifiers and/or flow assistants, preferably have a particle size of less than 30 μm, at least 9.0% of all particles in a particularly preferred embodiment of the invention having not more than 15 μm.

In a further advantageous embodiment, the core which has been compacted and especially extruded under mechanical pressure is powdered with one water-insoluble ingredient or a combination of two or more water-insoluble ingredients, especially from the group of the fatty acids, aluminosilicates, especially clays such as bentonites and smectites and also zeolites, and silicas, of which particular preference is given to aluminosilicates and especially the zeolites of the abovementioned type. Equally preferred is also a combination of aluminosilicates and silicas which are in particular hydrophobic, in which case a mixture of from 100 to 3 parts by weight of zeolite A, zeolite P and/or zeolite X for 1 part by weight of hydrophobic silica may be particularly advantageous. The preferred particle sizes for the water-insoluble ingredients are the same as for water-soluble ingredients.

However, preference is also given to mixtures of water-soluble and water-insoluble ingredients, especially mixtures of zeolites of the above-described fine type and calcium stearate.

Insofar as it does not concern the distinction between core and shell, the composition which has been compacted and especially extruded under mechanical pressure refers in the context of the present invention to the correspondingly produced core which has optionally been aftertreated as specified above.

Compared to the water content of conventional spray-dried or granulated compositions having comparable bulk densities, the water content of the inventive compositions is relatively low. In spite of the low water content, the compositions are not hygroscopic and remain free-flowing and stable even after storage.

As further ingredients, the inventive compositions may comprise additional further water-soluble builder substances, but also surfactants, and if desired also bleaches, bleach catalysts and/or bleach activators, soil-release and soil-repellent compounds, enzymes and enzyme stabilizers, foam inhibitors, UV absorbents, optical brighteners, neutral filler salts and colorants and dyes, all of which are already known from the prior art.

Suitable further water-soluble builders are polymeric polycarboxylates; these are, for example, the alkali metal salts of polyacrylic acid or of polymethacrylic acid, for example those having a relative molecular mass of from 500 to 70 000 g/mol.

In the context of this document, the molar masses specified for polymeric polycarboxylates are weight-average molar masses M_{w} of the particular acid form which has always been determined by means of gel permeation chromatography (GPC) using a UV detector. The measurement was effective against an external polyacrylic acid standard which, owing to its structural relationship with the polymers analyzed, affords realistic molar mass values. These data deviate distinctly from the molar mass data for which polystyrenesulfonic acids are used as the standard. The molar masses measured against polystyrenesulfonic acids are generally distinctly higher than the molar masses specified in this document.

Suitable polymers are in particular polyacrylates which preferably have a molecular mass of from 1000 to 20 000 g/mol. Owing to their superior solubility, the short-chain polyacrylates which have molar masses of from: 1000 to 10 000 g/mol and more preferably of from 1200 to 8000 g/mol, for example 4500 or 8000, may in turn be preferred from this group.

In the inventive compositions, particular preference is given to using both polyacrylates and copolymers of unsaturated carboxylic acids, sulfonic acid group-containing monomers and optionally further ionic or nonionogenic monomers.

Also suitable are copolymeric polycarboxylates, especially those of acrylic acid with methacrylic acid and of acrylic acid or methacrylic acid with maleic acid. Particularly suitable copolymers have been found to be those of acrylic acid with maleic acid which contain from 50 to 90% by weight of acrylic acid and from 50 to 10% by weight of maleic acid. Their relative molecular mass, based on the free acids, is generally from 2000 to 100 000 g/mol, preferably from 20 000 to 90 000 g/mol and in particular from 30 000 to 80 000 g/mol.

The content of (co)polymeric polycarboxylates in the particulate compositions is preferably from 0.5 to 20% by weight, in particular from 3 to 10% by weight.

To improve the water-solubility, the polymers may also contain allylsulfonic acids, for example allyloxybenzenesulfonic acid and methallylsulfonic acid, as monomers.

Especially preferred are also biodegradable polymers composed of more than two different monomer units, for example those which contain, as monomers, salts of acrylic acid and of maleic acid and vinyl alcohol or vinyl alcohol derivatives, or which contain, as monomers, salts of acrylic acid and of 2-alkylallylsulfonic acid and sugar derivatives.

Further preferred copolymers comprise, as monomers, preferably acrolein and acrylic acid/acrylic acid salts, or acrolein and vinyl acetate.

Further preferred builder substances to be mentioned are equally polymeric aminodicarboxylic acids, salts thereof or precursor substances thereof. Particular preference is given to polyaspartic acid or salts and derivatives thereof.

Further suitable builder substances are polyacetals which may be obtained by reacting dialdehydes with polyolcarboxylic acids which have from 5 to 7 carbon atoms and at least 3 hydroxyl groups. Preferred poly-acetals are obtained from dialdehydes such as glyoxal, glutaraldehyde, terephthalaldehyde and mixtures thereof, and from polyolcarboxylic acids such as gluconic acid and/or glucoheptonic acid.

Further suitable organic builder substances are dextrins, for example oligomers or polymers of carbohydrates, which can be obtained by partial hydrolysis of starches. The hydrolysis can be carried out by customary, for example acid-catalyzed or enzyme-catalyzed, processes. The hydrolysis products preferably have average molar masses in the range from 400 to 500 000 g/mol. Preference is given to a polysaccharide having a dextrose equivalent (DE) in the range from 0.5 to 40, in particular from 2 to 30, where DE is a common measure of the reducing action of a polysaccharide compared to dextrose which has a DE of 100. It is also possible to use maltodextrins with a DE between 3 and 20 and dry glucose syrups with a DE between 20 and 37, and also yellow dextrins and white dextrins having relatively high molar masses in the range from 2000 to 30 000 g/mol.

The oxidized derivatives of such dextrins are their reaction products with oxidizing agents which are capable of oxidizing at least one alcohol function of the saccharide ring to the carboxylic acid function. A product oxidized on C₆ of the saccharide ring may be particularly advantageous.

Oxydisuccinates and other derivatives of disuccinates, preferably ethylenediamine disuccinate, are also further suitable cobuilders. In this case, ethylenediamine N,N′-disuccinate (EDDS) is preferably used in the form of its sodium or magnesium salts. In this connection, preference is also given to glycerol disuccinates and glycerol trisuccinates. Suitable use amounts in zeolite-containing and/or silicate-containing compositions are from 3 to 15% by weight based on the overall composition.

Useful further cobuilders which may be present in liquid or particulate compositions or moldings together with phosphonates, but also as a partial or full replacement for phosphonates, include iminodisuccinates (IDS) and derivatives thereof, for example hydroxyl-iminodisuccinates (HDIS). It has already been known for some years that these raw materials can be used as cobuilders in detergent compositions. For instance, the use of HIDS in detergent compositions is described already in the patent applications WO 92/02489 and DE 43 11 440. The European patent application EP 0 757 094 discloses the advantageous use of iminodisuccinates in combination with polymers which have repeating succinyl units. In recent times, it has been discovered that IDS- or HIDS-containing compositions can make a positive contribution to the color retention of textiles.

Further organic cobuilders which can be used are, for example, acetylated hydroxycarboxylic acids or salts thereof, which may also be present in lactone form and which contain at least 4 carbon atoms and at least one hydroxyl group and a maximum of two acid groups.

A further substance class having cobuilder properties is that of the phosphonates. These are in particular hydroxyalkane- and aminoalkanephosphonates. Among the hydroxyalkanephosphonates, 1-hydroxyethane-1,1-diphosphonate (HEDP) is of particular importance as cobuilder. It is preferably used in the form of the sodium salt, the disodium salt giving a neutral reaction and the tetrasodium salt an alkaline reaction (pH 9). Useful aminoalkanephosphonates are preferably ethylenediaminetetramethylenephosphonate (EDTMP), diethylenetriaminepentamethylenephosphonate (DTPMP) and higher homologs thereof. They are preferably used in the form of the neutrally reacting sodium salts, for example as the hexasodium salt of EDTMP or as the hepta- and octasodium salt of DTPMP. From the class of the phosphonates, preference is given to using HEDP as builder. In addition, the aminoalkanephosphonates have a marked heavy metal-binding capacity. Accordingly, especially when the agents also comprise bleaches, it may be preferable to use aminoalkanephosphonates, especially DTPMP, or mixtures of the phosphonates mentioned.

In addition, it is possible to use all compounds which are capable of forming complexes with alkaline earth metal ions and are also water-soluble as cobuilders in the particulate compositions.

Useful surfactants of the sulfonate type are preferably C₉₋₁₃-alkylbenzenesulfonates, olefinsulfonates, i.e. mixtures of alkene- and hydroxyalkanesulfonates, and disulfonates, as are obtained, for example, from C₁₂₋₁₈-monoolefins with terminal or internal double bond by sulfonation with gaseous sulfur trioxide and subsequent alkaline or acidic hydrolysis of the sulfonation products. Also suitable are alkane-sulfonates which are obtained from C₁₂₋₁₈-alkanes, for example by sulfochlorination or sulfoxidation with subsequent hydrolysis or neutralization. In addition, the esters of α-sulfo fatty acids (ester sulfonates), for example the α-sulfonated methyl esters of hydrogenated coconut, palm kernel or tallow fatty acids, are also suitable.

Further suitable anionic surfactants are sulfated fatty acid glycerol esters, which constitute mono-, di- and triesters, and mixtures thereof, as are obtained in the preparation by esterification of a monoglycerol with from 1 to 3 mol of fatty acid or in the transesterification of triglycerides with from 0.3 to 2 mol of glycerol.

Preferred alk(en)yl sulfates are the alkali metal and in particular the sodium salts of the sulfuric monoesters of C₁₂-C₁₈ fatty alcohols, for example of coconut fatty alcohol, tallow fatty alcohol, lauryl alcohol, myristyl alcohol, cetyl alcohol or stearyl alcohol, or of C₁₀-C₂₀ oxo alcohols and those monoesters of secondary alcohols of these chain lengths. Also preferred are alk(en)ylsulfates of the chain length mentioned which contain a synthetic straight-chain alkyl radical prepared on a petrochemical basis and which have analogous degradation behavior to the equivalent compounds based on fatty chemical raw materials. From a washing technology point of view, C₁₆-C₁₈-alk(en)yl sulfates are especially preferred. It may be particularly advantageous, and advantageous especially for machine detergents, to use C₁₆-C₁₈-alk(en)yl sulfates in combination with lower-melting anionic surfactants and especially with those anionic surfactants which have a lower Krafft point and exhibit a low tendency to crystallize at relatively low washing temperatures of, for example, from room temperature to 40° C. In a preferred embodiment of the invention, the compositions therefore comprise mixtures of short-chain and long-chain fatty alkyl sulfates, preferably mixtures of C₁₂-C₁₄ fatty alkyl sulfates or C₁₂-C₁₈ fatty alkyl sulfates with C_{16-C}₁₈ fatty alkyl sulfates and in particular C₁₂-C₁₆ fatty alkyl sulfates with C₁₆-C₁₈ fatty alkyl sulfates. However, in a further preferred embodiment of the invention, not only saturated alkyl sulfates, but also unsaturated alkenyl sulfates having an alkenyl chain length of preferably from C₁₆ to C₂₂ are used. In this context, preference is given in particular to mixtures of saturated sulfated fatty alcohols consisting predominantly of C₁₆ and unsaturated sulfated fatty alcohols consisting predominantly of C₁₈, for example those which derive from solid or liquid fatty alcohol mixtures of the HD-Ocenol^{(R)} type (commercial product of the applicant). In these mixtures, preference is given to weight ratios of alkyl sulfates to alkenyl sulfates of from 10:1 to 1:2 and in particular of from about 5:1 to 1:1.

2,3-Alkyl sulfates, which can be prepared, for example, according to the U.S. Pat. No. 3,234,258 or 5,075,041 and obtained as commercial products from the Shell Oil Company under the name DAN^{(R)}, are also suitable anionic surfactants.

Also suitable are the sulfuric monoesters of the straight-chain or branched C₇₋₂₁-alcohols ethoxylated with 1 to 6 mol of ethylene oxide, such as 2-methyl-branched C₉₋₁₁-alcohols with on average 3.5 mol of ethylene oxide (EO) or C₁₂₋₁₈-fatty alcohols with from 1 to 4 EO. Owing to their high tendency to foam, they are used in detergents only in relatively small amounts, for example amounts of from 1 to 5% by weight.

Preferred anionic surfactants are also the salts of alkylsulfosuccinic acid, which are also referred to as sulfosuccinates or as sulfosuccinic esters and are the monoesters and/or diesters of sulfosuccinic acid with alcohols, preferably fatty alcohols and in particular ethoxylated fatty alcohols. Preferred sulfosuccinates contain C₈₋₁₈ fatty alcohol radicals or mixtures thereof. Especially preferred sulfosuccinates contain a fatty alcohol radical which derives from ethoxylated fatty alcohols which, considered alone, constitute nonionic surfactants (for description see below). In this context, particular preference is given in turn to sulfosuccinates whose fatty alcohol radicals derive from ethoxylated fatty alcohols with a narrowed homolog distribution. It is also equally possible to use alk(en)ylsuccinic acid having preferably from 8 to 18 carbon atoms in the alk(en)yl chain or salts thereof.

Preferred anionic surfactant mixtures comprise combinations of alcohol sulfates and alkylbenzenesulfonates, sulfated fatty acid glycerol esters and/or α-sulfo fatty acid esters and/or sulfosuccinates. Preference is given in this context in particular to mixtures which comprise, as anionic surfactants, alcohol sulfates and alkylbenzenesulfonates, alcohol sulfates and α-sulfo fatty acid methyl esters and/or sulfated fatty acid glycerol esters.

Useful further anionic surfactants are in particular soaps, preferably in amounts of from 0.2 to 2% by weight. Suitable soaps are in particular saturated fatty acid soaps, such as the salts of lauric acid, myristic acid, palmitic acid, stearic acid, hydrogenated erucic acid and behenic acid, and soap mixtures derived in particular from natural fatty acids, for example coconut, palm kernel or tallow fatty acids.

The anionic surfactants including the soaps may be present in the form of their sodium, potassium or ammonium salts, and also in the form of soluble salts of organic bases, such as mono-, di- or triethanolamine. The anionic surfactants are preferably present in the form of their sodium or potassium salts, in particular in the form of the sodium salts.

The content of anionic surfactants in the inventive compositions is preferably from 5 to 35% by weight and in particular from 10 to 30% by weight.

The nonionic surfactants used are preferably alkoxylated, advantageously ethoxylated, in particular primary alcohols having preferably from 8 to 18 carbon atoms and on average from 1 to 12 mol of ethylene oxide (EO) per mole of alcohol in which the alcohol radical may be linear or preferably 2-methyl-branched, or may contain a mixture of linear and methyl-branched radicals, as are typically present in oxo alcohol radicals. However, especially preferred alcohol ethoxylates have linear radicals of alcohols of natural origin having from 12 to 18 carbon atoms, for example of coconut, palm, tallow fat or oleyl alcohol, and on average from 2 to 8 EO per mole of alcohol. The preferred ethoxylated alcohols include, for example, C₁₂₋₁₄-alcohols having 3 EO or 4 EO, C₉₋₁₁-alcohols having 7 EO, C₁₃₋₁₅-alcohols having 3 EO, 5 EO, 7 EO or 8 EO, C₁₂₋₁₈-alcohols having 3 EO, 5 EO or 7 EO and mixtures thereof, such as mixtures of C₁₂₋₁₄-alcohol having 3 EO and C₁₂₋₁₈-alcohol having 7 EO. The degrees of ethoxylation specified are statistical average values which may be an integer or a fraction for a specific product. Preferred alcohol ethoxylates have a narrowed homolog distribution (narrow range ethoxylates, NRE). In addition to these nonionic surfactants, it is also possible to use fatty alcohols having more than 12 EO. Examples thereof are tallow fatty alcohol having 14 EO, 25 EO, 30 EO or 40 EO.

In addition, further nonionic surfactants which may be used are also alkyl glycosides of the general formula RO(G)ₓ in which R is a primary straight-chain or methyl-branched, in particular 2-methyl-branched, aliphatic radical having from 8 to 22, preferably from 12 to 18, carbon atoms and G is the symbol which represents a glycose unit having 5 or 6 carbon atoms, preferably glucose. The degree of oligomerization x, which specifies the distribution of monoglycosides and oligoglycosides, is any number between 1 and 10; x is preferably from 1.2 to 1.4.

A further class of nonionic surfactants used with preference, which are used either as the sole nonionic surfactant or in combination with other nonionic surfactants, in particular together with alkoxylated fatty alcohols and/or alkylglycosides, is that of alkoxylated, preferably ethoxylated or ethoxylated and propoxylated, fatty acid alkyl esters, preferably having from 1 to 4 carbon atoms in the alkyl chain, in particular fatty acid methyl esters, as are described, for example, in the Japanese patent application JP 58/217598 or which are prepared preferably by the process described in the international patent application WO-A-90/13533. Particular preference is given to C₁₂₋₁₈ fatty acid methyl esters with on average from 10 to 15 EO, in particular with on average 12 EO.

Nonionic surfactants of the amine oxide type, for example N-cocoalkyl-N,N-dimethylamine oxide and N-(tallow alkyl)-N,N-hydroxyethylamine oxide, and of the fatty acid alkanolamide type may also be suitable. The amount of these nonionic surfactants is preferably not more than that of the ethoxylated fatty alcohols, in particular not more than half thereof.

Further suitable surfactants are polyhydroxy fatty acid amides of the formula (I) 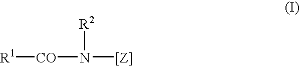
in which R¹CO is an aliphatic acyl radical having from 6 to 22 carbon atoms, R² is hydrogen, an alkyl or hydroxyalkyl radical having from 1 to 4 carbon atoms and [Z] is a linear or branched polyhydroxyalkyl radical having from 3 to 10 carbon atoms and from 3 to 10 hydroxyl groups.

The content of nonionic surfactants in the compositions is preferably from 1 to 15% by weight and in particular from 2 to 10% by weight.

Examples of cationic surfactants are quaternary ammonium compounds, cationic polymers and emulsifiers, as are used in haircare compositions and also in compositions for textile softening. In this context, preference is given in particular to the ester quats.

To enhance the washing or cleaning performance, inventive compositions may comprise enzymes, in which case it is possible in principle to use any enzymes established for these purposes in the prior art. These include in particular proteases, amylases, lipases, hemicellulases, cellulases or oxidoreductases, and preferably mixtures thereof. These enzymes are in principle of natural origin; starting from the natural molecules, improved variants are available for use in detergents and are preferably used accordingly. Inventive compositions preferably contain enzymes in total amounts of from 1×10⁻⁶ to 5 percent by weight based on active protein. The protein concentration may be determined with the aid of known methods, for example the BCA method (bicinchoninic acid; 2,2′-biquinolyl-4,4′-dicarboxylic acid) or the biuret method.

Among the proteases, preference is given to those of the subtilisin type. Examples thereof include the subtilisins BPN′ and Carlsberg, protease PB92, the subtilisins 147 and 309, Bacillus lentus alkaline protease, subtilisin DY and the enzymes thermitase and proteinase K which can be classified to the subtilases but no longer to the subtilisins in the narrower sense, and the proteases TW3 and TW7. The subtilisin Carlsberg is available in a developed form under the trade name Alcalase® from Novozymes A/S, Bagsv [symbol] rd, Denmark. The subtilisins 147 and 309 are sold under the trade names Esperase® and Savinase® respectively by Novozymes. The variants listed under the name BLAP® are derived from the protease of Bacillus lentus DSM 5483, and are described in particular in WO 92/21760, WO 95/23221 and in the applications DE 10121463 and DE 10153792. Further useful proteases from different Bacillus sp. and B. gibsonii are disclosed by the patent applications DE 10162727, DE 10163883, DE 10163884 and DE 10162728.

Further examples of useful proteases are the enzymes available under the trade names Durazym®, Relase®, Everlase®, Nafizym®, Natalase®, Kannase® and Ovozymes® from Novozymes, those under the trade names Purafect®, Purafect®OxP and Properase® from Genencor, that under the trade name Protosol® from Advanced Biochemicals Ltd., Thane, India, that under the trade name Wuxi® from Wuxi Snyder Bioproducts Ltd., China, those under the trade names Proleather® and Protease P® from Amano Pharmaceuticals Ltd., Nagoya, Japan and that under the name Proteinase K-16 from Kao Corp., Tokyo, Japan.

Examples of amylases which can be used in accordance with the invention are the α-amylases from Bacillus licheniformis, from B. amyloliquefaciens or from B. stearothermophilus and developments thereof which have been improved for use in detergents. The B. licheniformis enzyme is available from Novozymes under the name Termamyl® and from Genencor under the name Purastar®ST. Development products of this α-amylase are obtainable from Novozymes under the trade names Duramyl® and Termamyl®ultra, from Genencor under the name Purastar®OxAm and from Daiwa Seiko Inc., Tokyo, Japan as Keistase®. The B. amyloliquefaciens α-amylase is sold by Novozymes under the name BAN®, and variants derived from the B. stearothermophilus α-amylase under the names BSG® and Novamyl®, likewise from Novozymes.

Enzymes which should additionally be emphasized for this purpose are the α-amylase from Bacillus sp. A 7-7 (DSM 12368) which is disclosed in the application WO 02/10356, and the cyclodextrin glucanotransferase (CGTase) from B. agaradherens (DSM 9948) which is described in the application PCT/EP01/13278; and also those which belong to the sequence region of α-amylases which is defined in DE 10131441. It is equally possible to use fusion products of the molecules mentioned, for example those from DE 10138753.

Also suitable are the developments of α-amylase from Aspergillus niger and A. oryzae, which are available under the trade names Fungamyl® from Novozymes. Another commercial product is Amylase-LT®, for example.

Inventive compositions may comprise lipases or cutinases, especially owing to their triglyceride-cleaving activities, but also in order to generate peracids in situ from suitable precursors. Examples thereof include the lipases which were originally obtainable from Humicola lanuginosa (Thermomyces lanuginosus) or have been developed, in particular those with the D96L amino acid substitution. They are sold, for example, under the trade names Lipolase®, Lipolase®Ultra, LipoPrime®, Lipozyme® and Lipex® from Novozymes. It is additionally possible, for example, to use the cutinases which have originally been isolated from Fusarium solani pisi and Humicola insolens. Lipases which are also useful can be obtained under the designations Lipase CE®, Lipase P®, Lipase B®, Lipase CES®, Lipase AKG®, Bacillis sp. Lipase®, Lipase AP®, Lipase M-AP® and Lipase AML® from Amano. Examples of lipases and cutinases from Genencor which can be used are those whose starting enzymes have originally been isolated from Pseudomonas mendocina and Fusarium solanii. Other important commercial products include the M1 Lipase® and Lipomax® preparations originally sold by Gist-Brocades and the enzymes sold under the names Lipase MY-30®, Lipase OF® and Lipase PL® by Meito Sangyo KK, Japan, and also the product Lumafast® from Genencor.

Inventive compositions may, especially when they are intended for the treatment of textiles, comprise cellulases, depending on the purpose as pure enzymes, as enzyme preparations or in the form of mixtures in which the individual components advantageously complement one another with respect to their different performance aspects. These performance aspects include in particular contributions to the primary washing performance, to the secondary washing performance of the composition (antiredeposition action or graying inhibition) and finishing (fabric action), up to exerting a “stone-wash” effect.

A useful fungal, endoglucanase(EG)-rich cellulase preparation and developments thereof are supplied under the trade name Celluzyme® from Novozymes. The products Endolase® and Carezyme®, likewise available from Novozymes, are based on the H. insolens DSM 1800 50 kD EG and 43 kD EG respectively. Further possible commercial products of this company are Cellusoft® and Renozyme®. Likewise useful are the cellulases disclosed in the application WO 97/14804; for example the Melanocarpus 20 kD EG cellulase, which is available under the trade names Ecostone® and Biotouch® from AB Enzymes, Finland. Further commercial products from AB Enzymes are Econase® and Ecopulp®. Further suitable cellulase from Bacillus sp. CBS 670.93 and 669.93 are disclosed in WO 96/34092, and that from Bacillus sp. CBS 670.93 is available under the trade name Puradex® from Genencor. Other commercial products from Genencor are Genencor detergent cellulase L and IndiAge®Neutra.

Inventive compositions may comprise further enzymes which are combined under the term hemicellulases. These include, for example, mannanases, xanthane lyases, pectin lyases (=pectinases), pectin esterases, pectate lyases, xyloglucanases (=xylanases), pullulanases and β-glucanases. Suitable mannanases are available, for example, under the names Gamanase® and Pektinex AR® from Novozymes, under the name Rohapec® B1L from AB Enzymes and under the name Pyrolase® from Diversa Corp., San Diego, Calif., USA. A suitable β-glucanase from a. B. alcalophilus is disclosed, for example, by the application WO 99/06573. The β-glucanase obtained from B. subtilis is available under the name Cereflo® from Novozymes.

To enhance the bleaching action, inventive detergent compositions may comprise oxidoreductases, for example oxidases, oxygenases, catalases, peroxidases, such as haloperoxidases, chloroperoxidases, bromoperoxidases, lignin peroxidases, glucose peroxidases or manganese peroxidases, dioxygenases or laccases (phenol oxidases, polyphenol oxidases). Suitable commercial products include Denilite® 1 and 2 from Novozymes. Advantageously, preferably organic, more preferably aromatic, compounds which interact with the enzymes are additionally added in order to enhance the activity of the oxidoreductases in question (enhancers), or to ensure the electron flux in the event of large differences in the redox potentials of the oxidizing enzymes and the soilings (mediators).

The enzymes used in inventive compositions either derive originally from microorganisms, for example of the genera Bacillus, Streptomyces, Humicola, or Pseudomonas, and/or are produced in biotechnology processes known per se by suitable microorganisms, for instance by transgenic expression hosts of the genera Bacillus or filamentous fungi.

The enzymes in question are favorably purified by processes which are established per se, for example by precipitation, sedimentation, concentration, filtration of the liquid phases, microfiltration, ultrafiltration, the action of chemicals, deodorization or suitable combinations of these steps.

The enzymes may be added to inventive compositions in any form established in the prior art. These include, for example, the solid preparations obtained by granulation, extrusion or lyophilization, or, especially in the case of liquid or gel-form compositions, solutions of the enzymes, advantageously highly concentrated, low in water and/or admixed with stabilizers.

Alternatively, the enzymes may be encapsulated, for example by spray-drying or extrusion of the enzyme solution together with a preferably natural polymer, or in the form of capsules, for example those in which the enzymes are enclosed as in a solidified gel, or in those of the core-shell type, in which an enzyme-containing core is coated with a water-, air- and/or chemical-impermeable protective layer. It is possible in layers applied thereto to additionally apply further active ingredients, for example stabilizers, emulsifiers, pigments, bleaches or dyes. Such capsules are applied by methods known per se, for example by agitation or roll granulation or in fluidized bed processes. Advantageously, such granules, for example as a result of application of polymeric film formers, are low-dusting and storage-stable owing to the coating.

It is also possible to incorporate two or more enzymes together, so that a single granule has a plurality of enzyme activities.

A protein and/or enzyme present in an inventive composition may be protected, particularly during storage, from damage, for example inactivation, denaturation or decay, for instance by physical influences, oxidation or proteolytic cleavage. When the proteins and/or enzymes are obtained microbially, particular preference is given to inhibiting proteolysis, especially when the compositions also comprise proteases. For this purpose, inventive compositions may comprise stabilizers; the provision of such compositions constitutes a preferred embodiment of the present invention.

One group of stabilizers is that of reversible protease inhibitors. Frequently, benzamidine hydrochloride, borax, boric acids, boronic acids or salts or esters thereof are used, and of these in particular derivatives having aromatic groups, for example ortho-, meta- or para-substituted phenylboronic acids, or the salts or esters thereof. Peptide aldehydes, i.e. oligopeptides with reduced C-terminus are also suitable. Peptidic protease inhibitors which should be mentioned include ovomucoid and Leupeptin; an additional option is the formation of fusion proteins of proteases and peptide inhibitors.

Further enzyme stabilizers are amino alcohols such as mono-, di-, triethanol- and -propanolamine and mixtures thereof, aliphatic carboxylic acids up to C₁₂, such as succinic acid, other dicarboxylic acids or salts of the acids mentioned, or end group-capped fatty acid amide alkoxylates. Particular organic acids which are used as builders are also capable additionally of stabilizing an enzyme present.

Diglycerol phosphate likewise protects against denaturation by physical influences. Calcium salts are likewise used, for example calcium acetate or calcium formate, as are magnesium salts.

Polyamide oligomers or polymeric compounds such as lignin, water-soluble vinyl copolymers or cellulose ethers, acrylic polymers and/or polyamides stabilize the enzyme preparation against influences including physical influences. Polymers containing polyamine N-oxide act simultaneously as enzyme stabilizers and as dye transfer inhibitors. Other polymeric stabilizers are the linear C₈-C₁₈ polyoxyalkylenes. The alkylpolyglycosides already mentioned can stabilize the enzymatic components of the inventive composition and even increase their performance. Crosslinked N-containing compounds fulfill a double function as soil release agents and as enzyme stabilizers.

Reducing agents and antioxidants increase the stability of the enzymes against oxidative decay. Sulfur-containing reducing agents are disclosed, for example, by the patents EP 080748 and EP 080223. Other examples are sodium sulfite and reducing sugars.

Preference is given to using combinations of stabilizers, for example of polyols, boric acid and/or borax, the combination of boric acid or borate, reducing salts and succinic acid or other dicarboxylic acids, or the combination of boric acid or borate with polyols or polyamino compounds and with reducing salts. The action of peptide-aldehyde stabilizers can be enhanced by the combination with boric acid and/or boric acid derivatives and polyols, and further boosted by the additional use of divalent cations, for example calcium ions.

Even though enzymes are outstandingly suitable for being compacted and especially extruded under pressure, preference is given in a particular embodiment to preformulating the enzymes and optionally mixtures of 2, 3 or more of the enzymes and enzyme stabilizers mentioned, and using them afterward to produce the inventive compositions. The content of enzymes and enzyme stabilizers in the optionally produced composition is preferably from 0.5 to 3% by weight, based on the inventive composition or on the optionally produced composition.

In addition, the compositions may also comprise components which positively influence the ability to wash oil and fat out of textiles. This effect becomes particularly clear when a textile is soiled having already been washed repeatedly with an inventive detergent which comprises this oil- and fat-dissolving component. The preferred oil- and fat-dissolving components include, for example, nonionic cellulose ethers such as methylcellulose and methylhydroxypropylcellulose having a proportion of methoxy groups of from 15 to 30% by weight and a proportion of hydroxypropoxy groups of from 1 to 15% by weight, based in each case on the nonionic cellulose ethers, and also the polymers of phthalic acid and/or terephthalic acid or derivatives thereof which are known from the prior art, in particular polymers of ethylene terephthalates and/or polyethylene glycol terephthalates or anionically and/or nonionically modified derivatives thereof.

Further conceivable additives are foam inhibitors, for example foam-inhibiting paraffin oil or foam-inhibiting silicone oil, for example dimethylpolysiloxane. It is also possible to use mixtures of these active ingredients. Useful room temperature solid additives include, especially in the case of the foam-inhibiting active ingredients mentioned, paraffin waxes, silicas which may also be hydrophobicized in a known manner, and bisamides derived from C₂₋₇ diamines and C₁₂₋₂₂ carboxylic acids.

Foam-inhibiting paraffin oils which can be used and may be in a blend with paraffin waxes generally constitute complex substance mixtures without a sharp melting point. For characterization, the melting range is customarily determined by differential thermoanalysis (DTA) as described in “The Analyst” 87 (1962), 420, and/or the solidification point. This refers to the temperature at which the paraffin is converted by slow cooling from the liquid to the solid state. Paraffins having less than 17 carbon atoms cannot be used in accordance with the invention; their fraction in the paraffin oil mixture should therefore be as low as possible and is preferably below the significantly measurable limit which can be measured with customary analytical methods, for example gas chromatography. Preference is given to using paraffins which solidify in the range of from 20° C. to 70° C. It should be noted that even paraffin wax mixtures which appear to be solid at room temperature can contain varying amounts of liquid paraffin oils. In the paraffin waxes which can be used in accordance with the invention, the liquid proportion at 40° C. should be very high without already being 100% at this temperature. At 40° C., preferred paraffin wax mixtures have a liquid fraction of at least 50% by weight, in particular of from 55% by weight to 80% by weight, and, at 60° C., a liquid fraction of at least 90% by weight. This has the consequence that the paraffins are free-flowing and pumpable at temperatures down to at least 70° C., preferably down to at least 60° C. It should also be ensured that the paraffins contain as far as possible no volatile fractions. Preferred paraffin waxes contain less than 1% by weight, in particular less than 0.5% by weight, of fractions evaporable at 110° C. and standard pressure. Paraffins which can be used in accordance with the invention may be purchased, for example, under the trade names Lunaflex® from Fuller and Deawax® from DEA Mineralöl AG.

The paraffin oils may comprise room temperature solid bisamides which derive from saturated fatty acids having from 12 to 22, preferably from 14 to 18, carbon atoms, and from alkylenediamines having from 2 to 7 carbon atoms. Suitable fatty acids are lauric acid, myristic acid, stearic acid, arachic acid and behenic acid and mixtures thereof, as are obtainable from natural fats or hardened oils such as tallow or hydrogenated palm oil. Suitable diamines are, for example, ethylenediamine, 1,3-propylenediamine, tetramethylenediamine, pentamethylenediamine, hexamethylenediamine, p-phenylenediamine and tolylenediamine. Preferred diamines are ethylenediamine and hexamethylenediamine. Particularly preferred bisamides are bismyristoylethylenediamine, bispalmitoylethylenediamine, bisstearoylethylenediamine and mixtures thereof, and the corresponding derivatives of hexamethylenediamine.

The compositions may comprise UV absorbers, which attach to the treated textiles and improve the photostability of the fibers and/or the photostability of the other formulation constituents. UV absorbers refer to organic substances (light protection filters) which are capable of absorbing ultraviolet rays and emitting the energy absorbed again in the form of longer-wavelength radiation, for example heat. Compounds which have these desired properties are, for example, the compounds and derivatives of benzophenone which have substituents in the 2- and/or 4-position and are effective by virtue of radiationless deactivation. Also suitable are substituted benzotriazoles, 3-phenyl-substituted acrylates (cinnamic acid derivatives), optionally having cyano groups in the 2-position, salicylates, organic nickel complexes and natural substances such as umbelliferone and endogenous urocanic acid. Of particular significance are biphenyl derivatives and in particular stilbene derivatives as are described in EP 0728749 A and are available commercially as Tinosorb® FD or Tinosorb® FR ex Ciba. UV-B absorbers include 3-benzylidenecamphor or 3-benzylidenenorcamphor and derivatives thereof, for example 3-(4-methyl-benzylidene)camphor as described in EP 0693471 B1; 4-aminobenzoic acid derivatives, preferably 2-ethylhexyl 4-(dimethylamino)benzoate, 2-octyl 4-(dimethylamino)benzoate and amyl 4-(dimethylamino)benzoate; esters of cinnamic acid, preferably 2-ethylhexyl 4-methoxycinnamate, propyl 4-methoxycinnamate, isoamyl 4-methoxycinnamate, 2ethylhexyl 2-cyano-3,3-phenylcinnamate (octocrylene); esters of salicylic acid, preferably 2-ethylhexyl salicylate, 4-isopropylbenzyl salicylate, homomenthyl salicylate; derivatives of benzophenone, preferably 2-hydroxy-4-methoxybenzophenone, 2-hydroxy-4-methoxy-4′-methylbenzophenone, 2,2′-dihydroxy-4-methoxybenzophenone; esters of benzalmalonic acid, preferably di-2-ethylhexyl 4-methoxybenzmalonate; triazine derivatives, for example 2,4,6-trianilino(p-carbo-2′-ethyl-1′-hexyloxy)-1,3,5-triazine and Octyl Triazone as described in EP 0818450 A1, or Dioctyl Butamido Triazone (Uvasorbo HEB); propane-1,3-diones, for example 1-(4-tert-butylphenyl)-3-(4′-methoxyphenyl)propane-1,3-dione; ketotricyclo(5.2.1.0)decane derivatives as described in EP 0694521 B1. Also suitable are 2-phenylbenzimidazole-5-sulfonic acid and the alkali metal, alkaline earth metal, ammonium, alkylammonium, alkanolammonium and glucammonium salts thereof; sulfonic acid derivatives of benzophenones, preferably 2-hydroxy-4-methoxybenzophenone-5-sulfonic acid and its salts; sulfonic acid derivatives of 3-benzylidenecamphor, for example 4-(2-oxo-3-bornylidenemethyl)benzenesulfonic acid and 2-methyl-5-(2-oxo-3-bornylidene)sulfonic acid and salts thereof. Useful typical UV-A filters are in particular derivatives of benzoylmethane, for example 1-(4′-tert-butylphenyl)-3-(4′-methoxyphenyl)propane-1,3-dione, 4-tert-butyl-4′-methoxydibenzoylmethane (Parsol 1789), 1-phenyl-3-(4′-isopropylphenyl)propane-1,3-dione, and enamine compounds, as described in DE 19712033 A1 (BASF). The UV-A and UV-B filters can of course also be used in mixtures. In addition to the soluble substances mentioned, insoluble light protection pigments are also suitable for this purpose, specifically finely dispersed, preferably nanoized, metal oxides or salts. Examples of suitable metal oxides are in particular zinc oxide and titanium dioxide and additionally oxides of iron, zirconium, silicon, manganese, aluminum and cerium, and mixtures thereof. The salts used may be silicates (talc), barium sulfate or zinc stearate. The oxides and salts are already used in the form of pigments for skincare and skin-protection emulsions and decorative cosmetics. The particles should have an average diameter of less than 100 nm, preferably between 5 and 50 nm and in particular between 15 and 30 nm. They may have a spherical shape, although it is also possible to use particles which have an ellipsoidal shape or a shape which deviates in some other way from the spherical form. The pigments may also be surface-treated, i.e. hydrophilicized or hydrophobicized. Typical examples are coated titanium dioxides, for example titanium dioxide T 805 (Degussa) or Eusolex® T2000 (Merck). Useful hydrophobic coating compositions are in particular silicones and especially trialkoxyoctylsilanes or simethicones. Preference is given to using micronized zinc oxide. Further suitable UV light protection filters can be taken from the review of P. Finkel in SÖFW-Journal 122, 543 (1996). The UV absorbers are used typically in amounts of from 0.01% by weight to 5% by weight, preferably of from 0.03% by weight to 1% by weight.

The compositions may comprise, as optical brighteners, derivatives of diaminostilbenedisulfonic acid or alkali metal salts thereof. Suitable optical brighteners are, for example, salts of 4,4′-bis(2-anilino-4-morpholino-1,3,5-triazinyl-6-amino)stilbene-2,2′-disulfonic acid or compounds of a similar structure which bear, instead of the morpholino group, a diethanolamino group, a methylamino group, an aniline group or a 2-methoxyethylamino group. Brighteners of the substituted diphenylstyryl type may also be present, for example the alkali metal salts of 4,4′-bis(2-sulfostyryl)diphenyl, 4,4′-bis(4-chloro-3-sulfostyryl)diphenyl or 4-(4-chlorostyryl)-4′-(2-sulfostyryl)diphenyl. It is also possible to use mixtures of the aforementioned brighteners. It has been found that white granules are obtained uniformly when the compositions, apart from the customary brighteners in customary amounts, contain, for example, between 0.1 and 0.5% by weight, preferably between 0.1 and 0.3% by weight, even small amounts, for example from 10⁻⁶ to 10⁻³% by weight, preferably about 10⁻⁵% by weight, of a blue dye. A particularly preferred dye is Tinolux^{(R)} (commercial product from Ciba-Geigy).

The inventive compositions which have been compacted and especially extruded under pressure preferably have a relatively uniform appearance, the particle spectrum lying to an extent of virtually 100% by weight between 0.1 and 4 mm (both values inclusive), preferably between 0.4 and 2.0 mm (both values inclusive). Dust fractions having particle sizes less than 0.1 mm are preferably completely excluded.

The invention further relates to the production of the inventive compositions. In particular, a process according to the teaching of the international patent application WO 98/12299 is employed. Reference is made exclusively to the comprehensive description of the process in this document. Preference is given to a process in which a premixture which comprises individual raw materials and/or compounds which are present in solid form at room temperature and a pressure of 1 bar and have a melting point or softening point which is not below 45° C., and also optionally nonionic surfactants which are liquid at temperatures below 45° C. and a pressure of 1 bar but preferably not more than 10% by weight of these nonionic surfactants which are liquid at temperatures below 45° C. and a pressure of 1 bar, is initially prepared and, using compression forces at temperatures of at least 45° C., is converted to a granule and optionally subsequently further processed or formulated. In this process, the provisos apply that the premixture used does not have any free water and at least one raw material or compound which is present in the premixture is in solid form at a pressure of 1 bar and temperatures below 45° C. but as a melt under the processing conditions, this melt serving as a polyfunctional water-soluble binder which, in the course of the preparation of the compositions, performs both the function of a lubricant and an adhesive function for the solid detergent compounds or raw materials, but, in contrast, has a disintegrating action when the composition redissolves in aqueous liquor. According to these provisos, water may be introduced into the process for producing the premixture only in chemically and/or physically bound form or as a constituent of the raw materials or compounds present in solid form at temperatures below 45° C. at a pressure of 1 bar, but not as a liquid, solution or dispersion.

In a preferred embodiment of the invention, a binder is used which is already present fully as a melt at temperatures up to not more than 130° C., preferably up to not more than 100° C. and in particular up to 90° C. The binder thus has to be selected according to the process and process conditions, or the process conditions, especially the process temperature, have to be adjusted to the binder if a particular binder is desired.

Preferred binders which can be used alone or in a mixture with other binders are polyethylene glycols, 1,2-polypropylene glycols and also modified polyethylene glycols and polypropylene glycols. The modified polyalkylene glycols include in particular the sulfates and/or the disulfates of polyethylene glycols or polypropylene glycols having a relative molecular mass between 600 and 12 000 and in particular between 1000 and 4000. A further group consists of mono- and/or disuccinates of polyalkylene glycols which in turn have relative molecular masses between 600 and 6000, preferably between 1000 and 4000. For a more precise description of the modified polyalkylene glycol ethers, reference is made to the disclosure of the international patent application WO-A-93/02176. In the context of this invention, the polyethylene glycols include those polymers in whose preparation the starter molecules used are not only ethylene glycol but also C₃-C₅ glycols, and glycerol and mixtures thereof. Also included are ethoxylated derivatives such as trimethylolpropane with from 5 to 30 EO.

The polyethylene glycols used with preference may have a linear or branched structure, and preference is given in particular to linear polyethylene glycols.

The especially preferred polyethylene glycols include those having relative molecular masses between 1500 and 12 000 (both values inclusive), advantageously from around 1500 to 4000 (both values inclusive). However, the binders used may also be polyethylene glycols which are in the liquid state at room temperature and a pressure of 1 bar; this refers in particular to polyethylene glycol having a relative molecular mass of 200, 400 and 600. However, these liquid polyethylene glycols should only be used in a mixture with at least one further binder, and this mixture should again fulfill the inventive requirements, i.e. have a melting point or softening point of at least above 45° C.

The modified polyethylene glycols also include singly or multiply end group-capped polyethylene glycols, and the end groups are preferably C₁-C₁₂-alkyl chains which may be linear or branched. In particular, the end groups have alkyl chains between C₁ and C₆, in particular between C₁ and C₄, although isopropyl and isobutyl or tert-butyl also constitute entirely possible alternatives.

Singly end group-capped polyethylene glycol derivatives may also satisfy the formula Cₓ(EO)_{y}(PO)_{z} where Cₓ may be an alkyl chain having a carbon chain length of from 1 to 20, y may be from 50 to 500 and z may be from 0 to 20. For z=0, there exist overlaps with compounds of the preceding paragraph.

However, EO-PO polymers (x equals 0) may also serve as binders.

Equally suitable as binders are low molecular weight polyvinylpyrrolidones and derivatives thereof having relative molecular masses up to not more than 30 000. Preference is given in this context to relative molecular mass ranges between 3000 and 30 000, for example around 10 000. Polyvinylpyrrolidones are preferably not used as the sole binder, but rather in combination with others, in particular in combination with polyethylene glycols.

Suitable further binders have been found to be raw materials which themselves as raw materials have washing or cleaning properties, i.e., for example, nonionic surfactants with melting points of at least 45° C. or mixtures of nonionic surfactants and other binders. The preferred nonionic surfactants include alkoxylated fatty or oxo alcohols, in particular C₁₂-C₁₈ alcohols. Degrees of alkoxylation, especially degrees of ethoxylation, of, on average, from 18 to 100 AO, especially EO, per mole of alcohol and mixtures thereof have been found to be particularly advantageous. In particular, fatty alcohols with, on average, from 18 to 35 EO, in particular with, on average, from 20 to 25 EO, exhibit advantageous binder properties in the context of the present invention. In some cases, binder mixtures may also contain ethoxylated alcohols with, on average, fewer EO units per mole of alcohol, for example tallow fatty alcohol with 14 EO. However, preference is given to using these alcohols with relatively low degrees of ethoxylation only in a mixture with alcohols with higher degrees of ethokylation. Advantageously, the content of these alcohols with the relatively low degree of ethoxylation in the binders is less than 50% by weight, in particular less than 40% by weight, based on the total amount of binder used. In particular, nonionic surfactants used customarily in laundry detergents and cleaning compositions, such as C₁₂-C₁₈ alcohols with, on average, from 3 to 7 EO which are in liquid form at room temperature, are present in the binder mixtures preferably only in such amounts that less than 10% by weight, in particular less than 8% by weight and advantageously less than 2% by weight, of these nonionic surfactants, based in each case on the process end product, are thus provided. As has already been described above, it is, however, less preferred to use nonionic surfactants which are liquid at room temperature in the binder mixtures themselves. In a particularly advantageous embodiment, such nonionic surfactants are therefore not a constituent of the binder mixture since they not only lower the softening point of the mixture, but can also contribute to the tackiness of the end product and, moreover, as a result of their tendency to lead to gelation on contact with water, also often do not satisfy the requirement for rapid dissolution of the binder/the dividing wall in the end product to the desired degree. It is likewise not preferred that customary anionic surfactants used in washing or cleaning agents, or precursors thereof, the anionic surfactant acids, are present in the binder mixture. C₁₂-C₁₈ fatty alcohols, C₁₆-C₁₈ fatty alcohols or pure C₁₈ fatty alcohol with more than 50 EO, preferably with about 80 EO, by contrast, have been found to be exceptionally suitable binders which can be used alone or in combination with other binders.

Other nonionic surfactants which are suitable as binders are the fatty acid methyl ester ethoxylates which do not tend to gel, in particular those with, on average, from 10 to 25 EO (for a more precise description of this substance group see above), the representatives of this substance group preferred as nonionic surfactants thus possibly differing from the representatives preferred as binders. Particularly preferred representatives of this substance group are predominantly methyl esters based on C₁₆-C₁₈ fatty acids, for example hydrogenated beef tallow methyl ester with, on average, 12 EO or with, on average, 20 EO.

A further class of substances which are suitable as binders in the context of the present invention are ethoxylated fatty acids with from 2 to 100 EO, whose “fatty acid” radicals in the context of this invention may be linear or branched. Preference is given in particular to those ethoxylates which have a narrowed homolog distribution (NRE) and/or a melting point above 50° C. Such fatty acid ethoxylates may be used as the sole binder or in combination with other binders, while the nonethoxylated sodium and potassium soaps are less preferred and are used only in combination with other binders.

Likewise suitable as binders are also hydroxy mixed ethers, which can be obtained according to the teaching of European Patent Application EP-A-0 754 667 (BASF) by ring-opening epoxides of unsaturated fatty acid esters, especially in combination with polyethylene glycols, the aforementioned fatty acid methyl ester ethoxylates or the fatty acid ethoxylates.

Surprisingly, anhydrous swollen polymers, especially starch diphosphate/glycerol, polyvinylpyrrolidone/glycerol and modified cellulose/glycerol, for example hydroxypropylcellulose/glycerol, have been found to be outstandingly useful binders. In this context, from 5 to 20% by weight nonaqueous solutions of the polymers in glycerol, especially about 10% by weight nonaqueous solutions, are particularly advantageous.

In a preferred embodiment of the invention, the binder used is a mixture which comprises C₁₂-C₁₈ fatty alcohol based on coconut or tallow with, on average, 20 EO and polyethylene glycol with a relative molecular mass of from 400 to 4000.

In a further preferred embodiment of the invention, the binder used is a mixture which comprises methyl esters based predominantly on C₁₆-C₁₈ fatty acids and having, on average, from 10 to 25 EO, in particular hydrogenated beef tallow methyl ester with, on average, 12 EO or, on average, 20 EO, and a C₁₂-C₁₈ fatty alcohol based on coconut or tallow with, on average, 20 EO and/or polyethylene glycol with a relative molecular mass of from 400 to 4000.

Particularly advantageous embodiments of the invention have been found to be binders which are based either on polyethylene glycol with a relative molecular mass around 4000 alone, or on a mixture of C₁₂-C₁₈ fatty alcohol based on coconut or tallow with, on average, 20 EO and one of the above-described fatty acid methyl ester ethoxylates or on a mixture of C₁₂-C₁₈ fatty alcohol based on coconut or tallow with, on average, 20 EO, one of the above-described fatty acid methyl ester ethoxylates and a polyethylene glycol, especially with a relative molecular mass of from around 1500 to 4000. In this context, particular preference is given to mixtures of polyethylene glycol with a relative molecular mass of from around 1500 to 4000 with the fatty acid methyl ester ethoxylates specified or with C₁₆-C₁₈ fatty alcohol with 20 EO in a weight ratio of 1:1 or above.

Other raw materials such as trimethylol-propylene, etc. (commercial products from BASF, Federal Republic of Germany) may be present in binder mixtures, especially in a mixture with polyethylene glycols; however, they cannot be used as the sole binder, since they do fulfill a binding/tackifying function but have no disintegrating action.

In addition, further binders which can be used alone or in combination with other binders are also alkyl glycosides of the general formula RO(G)ₓ, as have already been described above. Especially suitable alkyl glycosides are those which have a softening point above 80° C. and a melting point above 140° C. Likewise suitable are highly concentrated compounds with contents of at least 70% by weight of alkyl glycosides, preferably at least 80% by weight of alkyl glycosides. Using high shear forces, the melt agglomeration and in particular the melt extrusion with compounds highly concentrated in this way can be carried out even at temperatures which are above the softening point, but still below the melting temperature. Although alkyl glycosides can also be used as the sole binder, it is preferred to use mixtures of alkyl glycosides and other binders. Especially here mixtures of polyethylene glycols and alkyl glycosides, advantageously in weight ratios of from 25:1 to 1:5, with particular preference from 10:1 to 2:1.

Likewise suitable as binders, especially in combination with polyethylene glycols and/or alkyl glycosides, are polyhydroxy fatty acid amides of the type likewise described above.

The content of binder or binders in the premixture is preferably at least 2% by weight, but less than 15% by weight, in particular less than 10% by weight, with particular preference from 3 to 6% by weight, based in each case on the premixture. Especially the anhydrously swollen polymers are used in amounts below 10% by weight, advantageously in amounts of from 4 to 8% by weight, with preference of from 5 to 6% by weight.

Surprisingly, it is also possible in the production of inventive compositions by the process described to produce compositions which have a bulk density of below 600 g/l. At the same time, it is possible, in comparison to formulations which are disclosed in the international patent application WO 98/12299, to produce the inventive compositions under lower pressures. In spite of this, the compositions remain cuttable as they pass out of the die of the extruder and do not adhere there.

In a particularly preferred embodiment of the invention, organic polycarboxylic acids are used in the process according to the invention, preferably in amounts of from 1 to 10% by weight and in particular in amounts of from 1 to 5% by weight.

The inventive compositions which have been compacted and especially extruded under pressure may be sold and used directly as detergent compositions. However, in a further preferred embodiment of the invention, the compositions are processed with further separately and subsequently added constituents of detergent compositions. This may be effective in such a way that the finished mix detergent compositions are obtained from a mixture of a plurality of different granules, of which the inventive compositions which have been compacted and especially extruded under mechanical pressure form the main constituent. It is also possible to use compositions which have been compacted and especially extruded under pressure and have a different composition, of which, for example, at least one is colored and serves as speckles. In a preferred embodiment, further ingredients, for example the enzymes already described above, but also bleaches, bleach catalysts and/or bleach activators, are added in the amounts customary for detergent compositions subsequently to the inventive compositions which have been compacted and especially extruded under mechanical pressure. It has also been found that the foaming behavior for detergents can be positively influenced when the foam inhibitor, for example organopolysiloxanes and mixtures thereof with microfine, optionally silanized, silica, and also paraffins, waxes, microcrystalline waxes and mixtures thereof with silanized silica or bistearylethylenediamine, are at least partly not extruded, but rather mixed subsequently with the extrudate. It is also possible that the surface of the inventive extrudate is covered, for example, first with zeolite or zeolite-containing mixture and subsequently with a foam inhibitor. Such measures enable a further improvement in the rinse-in performance of the composition which has been compacted and especially extruded under pressure.

To control microorganisms, the finished detergent compositions may comprise active antimicrobial ingredients. In this context, a distinction is drawn depending on antimicrobial spectrum and mechanism of action between bacteriostats and bactericides, fungistats and fungicides, etc. Important substances from these groups are, for example, benzalkonium chlorides, alkylarylsulfonates, halophenols and phenylmercuric acetate. In the context of the inventive teaching, the terms antimicrobial action and active antimicrobial ingredient have the definition customary in the art, which is reproduced, for example, by K. H. Wallhäusser in “Praxis der Sterilisation, Desinfektion—Konservierung: Keimidentifizierung—Betriebshygiene” [Practice of sterilization, disinfection—preservation: germ identification—workplace hygiene] (5th ed.—Stuttgart; New York: Thieme 1995), and all substances having antimicrobial action which are described there may be used. Suitable active antimicrobial ingredients are preferably selected from the groups of the alcohols, amines, aldehydes, antimicrobial acids or salts thereof, carboxylic esters, acid amides, phenols, phenol derivatives, diphenyls, diphenylalkanes, urea derivatives, oxygen and nitrogen acetals and formals, benzamidines, isothiazolines, phthalimide derivatives, pyridine derivatives, antimicrobial surface-active compounds, guanidines, antimicrobial amphoteric compounds, quinolines, 1,2-dibromo-2,4-dicyanobutane, iodo-2-propynylbutyl carbamate, iodine, iodophores, peroxo compounds, halogen compounds and any mixtures of the above.

The active antimicrobial ingredient may be selected from ethanol, n-propanol, isopropanol, 1,3-butanediol, phenoxyethanol, 1,2-propylene glycol, glycerol, undecylenic acid, benzoic acid, salicylic acid, dihydracetic acid, o-phenylphenol, N-methylmorpholino-acetonitrile (MMA), 2-benzyl-4-chlorophenol, 2,2′-methylenebis(6-bromo-4-chlorophenol), 4,4′-dichloro-2′-hydroxydiphenyl ether (dichlosan), 2,4,4′-trichloro-2′-hydroxydiphenyl ether (trichlosan), chlorohexidine, N-(4-chlorophenyl)-N-(3,4-dichlorophenyl)urea, N,N′-(1,10-decanediyldi-1-pyridinyl-4-ylidene)-bis(1-octanamine) dihydrochloride, N,N′-bis(4-chlorophenyl)-3,12-diimino-2,4,11,13-tetraazatetradecanediimideamide, glucoprotamines, antimicrobial surface-active quaternary compounds, guanidines including the bi- and polyguanidines, for example 1,6-bis(2-ethylhexyl-biguanidohexane) dihydrochloride, 1,6-di-(N₁,N₁′-phenyldiguanido-N₅,N₅′)hexane tetrahydrochloride, 1,6-di-(N₁,N₁′-phenyl-N₁,N₁′-methyldiguanido-N₅,N₅′) hexane dihydrochloride, 1,6-di-(N₁,N₁′-o-chlorophenyldiguanido-N₅,N₅′) hexane dihydrochloride, 1,6-di-(N₁,N₁′-2,6-dichlorophenyldiguanido-N₅,N₅′) hexane dihydrochloride, 1,6-di-[N₁,N₁′-beta-(p-methoxyphenyl) diguanido-N₅,N₅′]-hexane dihydrochloride, 1,6-di-(N₁,N₁′-alpha-methyl-beta-phenyldiguanido-N₅,N₅′)hexane dihydrochloride, 1,6-di-(N₁,N₁′-p-nitrophenyldiguanido-N₅,N₅′)hexane dihydrochloride, omega:omega-di-(N₁,N₁′-phenyldiguanido-N₅,N₅′)-di-n-propyl ether dihydrochloride, omega:omega′-di-(N₁,N₁′-p-chlorophenyldiguanido-N₅,N₅′)-di-n-propyl ether tetrahydrochloride, 1,6-di-(N₁,N₁-2,4-dichlorophenyldiguanido-N₅,N₅′)hexane tetrahydrochloride, 1,6-di-(N₁,N₁′-p-methylphenyldiguanido-N₅,N₅′)hexane dihydrochloride, 1,6-di-(N₁,N₁′-2,4,5-trichlorophenyldiguanido-N₅,N₅′)hexane tetrahydrochloride, 1,6-di-[N₁,N₁′-alpha-(p-chlorophenyl) ethyldiguanido-N₅,N₅′ ] hexane dihydrochloride, omega:omega-di-(N₁,N₁′-p-chlorophenyldiguanido-N₅,N₅′)ₘ-xylene dihydrochloride, 1,12-di-(N₁,N₁′-p-chlorophenyldiguanido-N₅,N₅′)dodecane dihydrochloride, 1,10-di-(N₁,N₁′-phenyldiguanido-N₅,N₅′)decane tetrahydrochloride, 1,12-di-(N₁,N₁′-phenyldiguanido-N₅,N₅′)dodecane tetrahydrochloride, 1,6-di-(N₁,N₁′-o-chlorophenyl-diguanido-N₅,N₅′) hexane dihydrochloride, 1,6-di-(N₁,N₁′-o-chlorophenyldiguanido-N₅,N₅′)hexane tetrahydrochloride, ethylenebis(1-tolylbiguanide), ethylenebis(p-tolylbi-guamide), ethylenebis(3,5-dimethylphenylbiguanide), ethylene-bis(p-tert-amylphenylbiguanide), ethylenebis-nonylphenylbiguanide), ethylenebis(phenylbiguanide), ethylenebis(N-butylphenylbiguanide), ethylenebis(2,5diethoxyhenylbiguanide), ethylenebis(2,4-dimethylphenylbiguanide), ethylenebis(o-diphenylbiguanide), ethylene-bis(mixed amyl naphthylbiguanide), N-butylethylene-bis(phenylbiguanide), trimethylenebis(o-tolylbiguanide), N-butyl-trimethylbis(phenylbiguanide); and the corresponding salts such as acetates, gluconates, hydrochlorides, hydrobromides, citrates, bisulfites, fluorides, polymaleates, N-cocoalkylsarcosinates, phosphites, hypophosphites, perfluorooctanoates, silicates, sorbates, salicylates, maleates, tartrates, fumarates, ethylenediaminetetraacetates, iminodiacetates, cinnamates, thiocyanates, arginates, pyromellitates, tetracarboxybutyrates, benzoates, glutarates, monofluorophosphates, perfluoropropionates, and any mixtures thereof. Also suitable are halogenated xylene and cresol derivatives, such as p-chlorometacresol or p-chlorometaxylene, amphoterics and natural active antimicrobial ingredients of plant origin (for example from spices or herbs), animal origin and microbial origin. Preference may be given to using antimicrobial surface-active quaternary compounds, a natural antimicrobial agent of plant origin and/or a natural antimicrobial agent of animal origin, most preferably at least one natural antimicrobial agent of plant origin from the group comprising caffeine, theobromine and theophylline and essential oils such as eugenol, thymol and geraniol, and/or at least one natural antimicrobial agent of animal origin from the group comprising enzymes such as milk protein, lysozyme and lactoperoxidase, and/or at least one antimicrobial surface-active quaternary compound having an ammonium, sulfonium, phosphonium, iodonium or arsonium group, peroxo compounds and chlorine compounds. It is also possible to use substances of microbial origin, the “bacteriocines”.

The quaternary ammonium compounds (QACs) which are suitable as active antimicrobial ingredients have the general formula (R³) (R⁴) (R⁵) (R⁶) N⁺X⁻ in which R³ to R⁶ are identical or different C₁-C₂₂-alkyl radicals, C₇-C₂₈-aralkyl radicals or heterocyclic radicals, where two, or in the case of an aromatic incorporation such as in pyridine, even three radicals, together with the nitrogen atom, form the heterocycle, for example a pyridinium or imidazolinium compound, and X⁻ are halide ions, sulfate ions, hydroxide ions or similar anions. For optimal antimicrobial action, at least one of the radicals preferably has a chain length of from 8 to 18, in particular 12 to 16, carbon atoms.

QACs can be prepared by reacting tertiary amines with alkylating agents such as, for example, methyl chloride, benzyl chloride, dimethyl sulfate, dodecyl bromide, or else ethylene oxide. The alkylation of tertiary amines having one long alkyl radical and two methyl groups proceeds particularly readily, and the quaternization of tertiary amines having two long radicals and one methyl group can also be carried out with the aid of methyl chloride under mild conditions. Amines which have three long alkyl radicals or hydroxy-substituted alkyl radicals have low reactivity and are preferably quaternized using dimethyl sulfate.

Examples of suitable QACs are benzalkonium chloride (N-alkyl-N,N-dimethylbenzylammonium chloride, CAS No. 8001-54-5), benzalkone B (m,p-dichlorobenzyldimethyl-C12-alkylammonium chloride, CAS No. 58390-78-6), benzoxonium chloride (benzyldodecylbis(2-hydroxyethyl)ammonium chloride), cetrimonium bromide (N-hexadecyl-N,N-trimethylammonium bromide, CAS No. 57-09-0), benzetonium chloride (N,N-dimethyl-N-[2-[2-[p-(1,1,3,3-tetramethyl-butyl)phenoxy]ethoxy]ethyl]-benzylammonium chloride, CAS No. 121-54-0), dialkyldimethylammonium chlorides such as di-n-decyldimethylammonium chloride (CAS No. 7173-51-5-5), didecyldimethylammonium bromide (CAS No. 2390-68-3), dioctyldimethylammonium chloride, 1-cetylpyridinium chloride (CAS No. 123-03-5) and thiazoline iodide (CAS No. 15764-48-1), and mixtures thereof. Particularly preferred QACs are the benzalkonium chlorides having C₈-C₁₈-alkyl radials, in particular C₁₂-C₁₄-alkylbenzyldimethylammonium chloride.

Benzalkonium halides and/or substituted benzalkonium halides are commercially available, for example, as Barquat® ex Lonza, Marquat® ex Mason, Variquat® ex Witco/Sherex and Hyamine® ex Lonza, and Bardac® ex Lonza. Further commercially available active antimicrobial ingredients are N-(3-chloroallyl)hexaminium chloride such as Dowicide® and Dowicil® ex Dow, benzethonium chloride such as Hyamine® 1622 ex Rohm & Haas, methylbenzethonium chloride such as Hyamine® 10× ex Rohm & Haas, cetylpyridinium chloride such as cepacol chloride ex Merrell Labs. The antimicrobially active substances may also be compacted and especially extruded under mechanical pressure; however, preference is given to adding these substances subsequently and optionally in compounded form with other substances.

Among the compounds which serve as bleaches and supply H₂O₂ in water, sodium perborate tetrahydrate and sodium perborate monohydrate are of particular significance. Further bleaches which can be used are, for example, sodium percarbonate, peroxypyrophosphates, citrate perhydrates, and H₂O₂-supplying peracidic salts or peracids, such as perbenzoates, peroxophthalates, diperazelaic acid, phthaloimino peracid or diperdodecanedloic acid. The content of bleaches in the compositions is preferably from 5 to 25% by weight and in particular from 10 to 20% by weight, and perborate monohydrate or percarbonate are used advantageously.

Bleach activators which may be used are compounds which, under perhydrolysis conditions, give rise to aliphatic peroxocarboxylic acids having preferably from 1 to 10 carbon atoms, in particular from 2 to 4 carbon atoms, and/or optionally substituted perbenzoic acid. Suitable substances bear O-acyl and/or N-acyl groups of the number of carbon atoms specified, and/or optionally substituted benzoyl groups. Preference is given to polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or iso-nonanoyloxybenzenesulfonate (n- or iso-NOBS), carboxylic anhydrides, in particular phthalic anhydride, acylated polyhydric alcohols, in particular triacetin, ethylene glycol diacetate, 2,5-diacetoxy-2,5-dihydrofuran and enol esters, and also acetylated sorbitol and mannitol or mixtures thereof (SORMAN), acylated sugar derivatives, in particular pentaacetylglucose (PAG), pentaacetylfructose, tetraacetylxylose and octaacetyllactose, and acetylated, optionally N-alkylated, glucamine and gluconolactone, and/or N-acylated lactams, for example N-benzoyl-caprolactam, and also further bleaches, bleach activators and/or bleach catalysts known from the prior art.

### EXAMPLES

### Example 1

In accordance with the teaching of the international patent application WO 98/12299, the inventive composition M1 and the comparative composition C1 were produced. The formulations are specified below. The ingredients mentioned, with the exception of the spray-dried zeolite A, were extruded at an extrusion pressure of 77 mbar (M1) or 102 bar (C1) and a cutoff temperature of 103° C. (M1) or 109° C. (C1), and cut directly after passing out of the die. The binder and lubricant having solid character at temperatures below 45° C. which was used was polyethylene glycol 1500. Subsequently, the extrudates were powdered with zeolite A under the same conditions in the rounder. The bulk densities were 660 g/l (M1) and 780 g/l (C1) respectively. The L test (see below) gave 10% for M1, but 19% for C1. The particle size spectrum both of M1 and of C1 lay in each case to an extent of 100% by weight in the region of from 0.4 to 2.0 mm. Despite the pH of M1 of distinctly less than 10.5 (actually 9.5), the fragrance assessment gave the rating “acceptable”. No change in the fragrance note compared to C1 could be detected.

Compositions
(data in %
by weight):

| | M1 | C1 |
|---|---|---|
| Alkylbenzenesulfonate | 17.0 | 17.0 |
| (sodium salt) | | |
| C₁₂-C₁₈ fatty alcohol sulfate | 6.7 | 6.7 |
| (sodium salt) | | |
| Sodium stearate | 1.0 | 1.0 |
| Octyl sulfate (sodium salt) | 2.3 | 2.3 |
| C₁₂-C₁₈ fatty alcohol with 7 EO | 5.5 | 5.5 |
| Phosphonates (HEDP and DETPMP) | 1.9 | 1.9 |
| Polyethylene glycol (relative | 2.8 | 2.8 |
| molecular mass 1500) | | |
| Sodium citrate with 1 H₂O | 3.0 | — |
| (used in the process as | | |
| citric acid, 100% neutralization) | | |
| Sodium citrate with 2 H₂O | 20.5 | 23.5 |
| Sodium carbonate | 4.7 | 4.7 |
| Sodium bicarbonate | 9.0 | 9.0 |
| Sodium salt of an acrylic acid- | 5.4 | 5.4 |
| maleic acid copolymer | | |
| (Sokalan CP5 ®) | | |
| Sodium sulfate | 12.5 | 12.5 |
| Water (chemically or physically | 3.2 | 3.2 |
| bound) | | |
| Salts from raw materials | Remainder | Remainder |
| Spray-dried zeolite A (with | 3.5 | 3.5 |
| approx. 22% by weight of water) | | |

### Example 2

In accordance with the teaching of the international patent application WO 98/12299 and analogously to example 1, the compositions C2 and C3 were produced, whose formulations are specified below. The ingredients mentioned, with the exception of 3.55% by weight of the spray-dried zeolite A, were extruded at an extrusion pressure of 78 bar (C2) or 65 bar (C3) and cut directly after passing out of the die. The binder and lubricant having solid character at temperatures below 45° C. which was used was polyethylene glycol 4000. Subsequently, the extrudates C2 and C3 were powdered with 3.55% by weight of spray-dried zeolite A under in each case the same conditions and under comparable conditions to those in example 1. The particle size spectrum both of C2 and of C3 lay in each case to an extent of 100% by weight in the region of from 0.4 to 2 mm. The value of the L test both for C2 at 8.6% and for C3 at 9.8% lay within a comparable order of magnitude to that for M1 and thus in the acceptable range. The bulk density was 790 g/l for C2, 730 g/l for C3. In zeolite-containing compositions too, the replacement of the citrate with citric acid thus led to a lowering in bulk density. However, this is distinctly smaller than in example 1. C2 had a pH of 10.7, while the pH of C3 was 9.5 (in each case measured at 20° C., 1% solution in water). As expected, the fragrance assessments of C2 gave a rating “acceptable”, while C3 had an unpleasantly altered, acid odor which had to be rated “unacceptable”.

Compositions
(data in %
by weight):

| | C2 | C3 |
|---|---|---|
| Alkylbenzenesulfonate | 17.0 | 17.0 |
| (sodium salt) | | |
| C₁₂-C₁₈ fatty alcohol sulfate | 6.5 | 6.5 |
| (sodium salt) | | |
| Sodium stearate | 1.0 | 1.0 |
| C₁₂-C₁₈ fatty alcohol with | 7.3 | 7.3 |
| 4-7 EO on average | | |
| Polyethylene glycol (relative | 2.2 | 2.2 |
| molecular mass 4000) | | |
| Carboxymethylcellulose (sodium | 1.2 | 1.2 |
| salt) | | |
| Phosphonate | 1.2 | 1.2 |
| Sodium citrate with 1 H₂O | 3.0 | 3.0 |
| (used as citric acid in the | | |
| production of C3) | | |
| Zeolite A (calculated as anhydrous | 38.7 | 38.7 |
| active substance | | |
| Sodium carbonate | 0.5 | 0.5 |
| Sodium salt of an acrylic acid- | 4.7 | 4.7 |
| maleic acid copolymer | | |
| Sodium sulfate | 4.3 | 4.3 |
| Water (chemically or physically | 11.0 | 11.0 |
| bound) | | |
| Salts from raw materials | Remainder | Remainder |

Determination of the Solubility (L Test):

To determine the residue performance and the solubility performance, 8 g of the composition to be tested were scattered in a 2 l beaker with stirring (800 rpm with laboratory stirrer/propeller stirrer head, centered 1.5 cm from the beaker bottom) and stirred at 30° C. for 1.5 minutes. The experiment was carried out with water having a German hardness of 16°. Subsequently, the wash liquor was poured off through a sieve (80 μm). The beaker was washed out with a very small amount of cold water through the sieve. A double determination was effected. The sieves were dried to constant weight in a drying cabinet at 40° C.±2° C. and the detergent residue was weighed. The residue is specified as the average of the two individual determinations in percent. In the event of deviations of the individual results by more than 20% from one another, further experiments were customarily carried out; this was, though, unnecessary in the present investigations.

As used herein, and in particular as used herein to define the elements of the claims that follow, the articles “a” and “an” are synonymous and used interchangeably with “at least one” or “one or more,” disclosing or encompassing both the singular and the plural, unless specifically defined otherwise. The conjunction “or” is used herein in its inclusive disjunctive sense, such that phrases formed by terms conjoined by “or” disclose or encompass each term alone as well as any combination of terms so conjoined, unless specifically defined otherwise. All numerical quantities are understood to be modified by the word “about,” unless specifically modified otherwise or unless an exact amount is needed to define the invention over the prior art.

1. A detergent composition comprising a compactate, wherein the compactate comprises one or more organic polycarboxylic acids and/or salts thereof, wherein the compactate comprises no more than 5% by weight of water-insoluble builder substances, and the pH of a 1% solution of the detergent composition in water at 20° C. is below 10.5.

2. The composition of claim 1, wherein the pH is at most 10.2.

3. The composition of claim 2, wherein the pH is at most 10.0.

4. The composition of claim 3, wherein the pH is 9.0 to 9.9.

5. The composition of claim 1 having a bulk density of not more than 750 g/l.

6. The composition of claim 1, wherein the compactate is free of water-insoluble builder substances.

7. The composition of claim 1, wherein the compactate has a subsequently-applied powder coating comprising one or more water-soluble ingredients selected from the group consisting of amorphous silicates, sulfates, fatty acid salts, alkali metal carbonates, and alkali metal hydrogen-carbonates.

8. The composition of claim 1, wherein the compactate has a subsequently-applied powder coating comprising one or more water-insoluble ingredients selected from the group consisting of fatty acids, aluminosilicates, and silicas.

9. The composition of claim 1, having a bulk density of at most 720 g/l.

10. The composition of claim 9, having a bulk density of 500 to 700 g/l.

11. The composition of claim 1, comprising a builder system that comprises one or more water-soluble inorganic builder substances selected from the group consisting of carbonates, amorphous alkali metal silicates, crystalline sheet silicates, and phosphates.

12. The composition of claim 11, wherein the builder system comprises a combination of a carbonate and a bicarbonate.

13. The composition of claim 12, wherein the builder system comprises 10 to 80% by weight of a combination of an alkali metal carbonate and an alkali metal bicarbonate, based on the sum of the water-soluble builder substances in the composition.

14. The composition of claim 13, wherein the builder system comprises 20 to 60% by weight of a combination of an alkali metal carbonate and an alkali metal bicarbonate.

15. The composition of claim 1, wherein the organic poly-carboxylic acid and/or salt thereof comprises a combination of two or more acids and/or salts thereof selected from the group consisting of citric acid, adipic acid, succinic acid, glutaric acid, malic acid, tartaric acid, maleic acid, fumaric acid, sugar acids, aminocarboxylic acids, and nitrilotriacetic acid.

16. The composition of claim 1, having a content of organic polycarboxylic acids and/or salts thereof, based on the sum of the water-soluble builder substances, of at least 30% by weight.

17. The composition of claim 16, having a content of organic polycarboxylic acids and/or salts thereof, based on the sum of the water-soluble builder substances, of at least 35% by weight.

18. The composition of claim 1, having a content of salts of organic polycarboxylic acids of 5 to 35% by weight.

19. The composition of claim 18, having a content of salts of organic polycarboxylic acids of 10 to 30% by weight.

20. The composition of claim 19, having a content of salts of organic polycarboxylic acids of 10 to 25% by weight.

21. The composition of claim 1, comprising carbonate and/or bicarbonate and citric acid and/or citrate in a weight ratio of 3:1 to 1:2.

22. The composition of claim 21, comprising carbonate and/or bicarbonate and citric acid and/or citrate in a weight ratio of 2:1 to 1:1.

23. The composition of claim 1, comprising 1 to 10% by weight of organic polycarboxylic acids that have been neutralized partly or fully during preparation of the composition.

24. The composition of claim 23, comprising 1 to 5% by weight of organic polycarboxylic acids that have been neutralized partly or fully during preparation of the composition.

25. A process for producing a detergent composition, comprising the steps of forming a premixture, said premixture comprising (1) individual raw materials and/or compounds that are present in solid form at room temperature and a pressure of 1 bar and have a melting point or softening point not below 45° C., (2) no free water, (3) 1 to 10% by weight of one or more organic polycarboxylic acids, (4) at least one raw material or compound present in the premixture in solid form at a pressure of 1 bar and temperatures below 45° C. but as a melt under later processing and, optionally, (5) nonionic surfactants that are liquid at temperatures below 45° C. and a pressure of 1 bar, and applying a compression force at temperatures of at least 45° C. to convert the premixture to a compactate.

26. The process of claim 25, wherein the premixture comprises from 1 to 5% by weight of the organic polycarboxylic acids.
